(19) United States
(12) Patent Application Publication
(10) Pub. No.: US 2007/0116322 A1
(43) Pub. Date: May 24, 2007

(54) Speaker apparatus

(75) Inventors: Minoru Horigome, Tendo-shi (JP); Teruaki Kaiya, Tendo-shi (JP); Yuichi Takahashi, Tendo-shi (JP)

Correspondence Address: SUGHRUE-265550, 2100 PENNSYLVANIA AVE. NW, WASHINGTON, DC, 20037-3213, US

(73) Assignees: PIONEER CORPORATION; TOHOKU PIONEER CORPORATION

(21) Appl. No.: 11/594,768

(22) Filed: Nov. 9, 2006

(30) Foreign Application Priority Data
Nov. 11, 2005 (JP) P2005-326983

(51) Int. Cl. H04R 9/06

(52) U.S. Cl. 381/396; 381/398

(57) ABSTRACT

According to an aspect of the invention, there is provided a speaker apparatus including: a magnetic circuit; a vibrating plate vibrated by the magnetic circuit; a speaker frame holding the magnetic circuit and the vibrating plate, and a connecting portion connecting a portion of holding the vibrating plate and a portion of holding the magnetic circuit, an inclined face of the connecting portion being inclined relative to a direction of tangential line of circumference of the speaker frame, the connecting portion configured to flow air due to a vibration of the vibrating plate along the inclined face thereof.

### CROSS-REFERENCE TO RELATED APPLICATIONS

This application is based on and claims the benefit of priority from the prior Japanese Patent Application No. 2005-326983, filed on Nov. 11, 2005; the entire contents of which are incorporated herein by reference.

### BACKGROUND

1. Technical Field

The present invention relates to a speaker apparatus.

2. Related Art

FIG. 1 shows a constitution of a related-art general dynamic speaker apparatus.

The speaker apparatus 1 includes; a magnetic circuit 3; a frame 5 attached with the magnetic circuit 3 at a rear portion thereof; a vibrating plate 9 of a cone-like shape in which an edge 7 in a roll-like shape at an outer periphery thereof is fixed to a vibrating plate supporting portion 5a of a front portion of the frame 5, and a voice coil 12 wound around a voice coil bobbin 11 in a cylindrical shape.

The magnetic circuit 3 includes a yoke 15 projecting a center pole 15b in a cylindrical shape at a center of a plate 15a in a shape of a circular plate, a magnet 16 in a ring-like shape fitted to an outer periphery of the center pole 15b, and a top plate 17 in a ring-like shape fitted to be mounted to a front end side of the center pole 15b to interpose the magnet 16 between the top plate 17 and the plate 15a.

A gap between an inner periphery of the top plate 17 and the center pole 15b serves as a magnetic gap 19 for arranging the voice coil 12.

The vibrating plate 9 is formed with an opening portion 9a for inserting the voice coil bobbin 11 at a center thereof. The edge 7 bonded to an outer peripheral edge of the vibrating plate 9 is fixed to the vibrating plate supporting portion 5a. An attaching flange 7a mounted to an outer periphery of the edge 7 is interposed between a gasket 21 in a ring-like shape pasted to the vibrating plate supporting portion 5a and the vibrating plate supporting portion 5a.

Further, an inner peripheral portion 9b of the vibrating plate 9 forming the opening portion 9a is fixed to an outer periphery of the voice coil bobbin 11 inserted to the opening portion 9a by adhering or the like.

Further, a center portion of the vibrating plate 9 is pasted with a dust cap 28. The dust cap 28 covers a front side of the voice coil bobbin 11 to prevent dust and dirt from invading the magnetic gap 19.

The voice coil bobbin 11 in the cylindrical shape is fitted to an outer periphery of the center pole 15b movably in an axial direction and is elastically supported by the frame 5 by a damper 25 to restrict movement thereof in the axial direction.

Normally, there is spread the damper 25 forming a bellows structure concentrically with the voice coil bobbin 11.

The damper 25 damps the vibrating plate 9 by restricting displacement of the voice coil bobbin 11 in a radius direction by fixing an outer peripheral edge thereof to a damper supporting portion 5b of the frame 5 and fixing an inner peripheral portion thereof to an outer periphery of the voice coil bobbin 11 and absorbing vibration energy by deforming the bellows in driving the vibrating plate 9.

The frame 5 is normally configured by a structure of providing a plurality of frame openings 5c formed at pertinent intervals along a circumferential direction of the speaker between the vibrating plate supporting portion 5a and the damper supporting portion 5b. The frame opening 5c functions as a vent hole for releasing an air flow produced by a back pressure in driving the vibrating plate 9.

Further, the frame opening 5c not only functions as the above-described vent hole but also constitutes light-weighted formation of the frame 5.

When a sound signal is inputted to the voice coil 12, the above-described speaker apparatus 1 reproduces sound by vibrating the vibrating plate 9 by reciprocally vibrating the voice coil bobbin 11 thereby.

Recently, examples of employing a large-sized speaker for reproducing low frequency sound, such as subwoofer, are increasing in a car-audio system.

When the large-sized speaker apparatus is designed for the car-audio system, a depth dimension of a portion utilized as a cabinet of the speaker apparatus such as a vehicle-mounted speaker cabinet or an inner side of a vehicle door is limited and therefore, it may be subject to thin the speaker apparatus.

However, according to the related-art speaker apparatus 1 in which the voice coil bobbin 11 is elastically supported by the damper 25 as described above, a space of arranging the damper 25 needs to provide between the vibrating plate 9 and the magnetic circuit 3. It is difficult to shorten a dimension in the axial direction of the speaker apparatus in order to provide the space of installing the damper 25.

Further, a stiffness of the damper 25 is normally larger than that of the edge 7 and therefore, mechanical fatigue by a long period of time of use is brought about earlier than in the edge 7 and there is a concern of causing a failure by deteriorating a control function.

Further, there is also a possibility of generating particular vibration or a brazing sound by deforming the bellows in propagating vibration between the contiguous bellows on the damper 25, which conversely effects an influence on the vibration of the voice coil 12 or the vibrating plate 9 to deteriorate sound quality. (refer to, for example, JP-A-2005-191746).

Further, it is a problem for the speaker apparatus how to cool heat generated by the magnetic circuit particularly by narrowing the installing space by thinning the speaker apparatus. A number of proposals have been made for cooling speaker apparatus (refer to, for example, JP-A-2003-299185).

However, the inner side of the speaker cabinet or the inner side of the vehicle door does not allow to be attached with the thinned speaker apparatus. A space at a back face of the attached speaker apparatus is narrowed. Therefore, it is difficult to smoothly move an air flow by the back pressure in driving the vibrating plate. Sound quality of the speaker is deteriorated. Further, when movement of the air flow is deteriorated, heat generated by the magnetic circuit of the speaker is hampered from being exhausted.

On the other hand, when the vent hole for making the air flow smooth is enlarged, a strength of the speaker frame is reduced. Therefore, it is difficult to hold the magnetic circuit.

The present invention has been made in view of the above circumstances and provides a speaker apparatus. According to an aspect of the invention, the problem that the air flow due to the back pressure in driving the vibrating plate is not moved smoothly in the related-art speaker apparatus can be solved without a reduction in the strength of the speaker frame.

According to an aspect of the invention, there is provided a speaker apparatus including: a magnetic circuit; a vibrating plate vibrated by the magnetic circuit; a speaker frame holding the magnetic circuit and the vibrating plate, and a connecting portion connecting a portion of holding the vibrating plate and a portion of holding the magnetic circuit, an inclined face of the connecting portion being inclined relative to a direction of tangential line of circumference of the speaker frame, the connecting portion configured to flow an air due to a vibration of the vibrating plate along the inclined face thereof.

### BRIEF DESCRIPTION OF THE DRAWINGS

FIG. 1 is a vertical sectional view showing a related-art speaker apparatus.

FIG. 2 is a perspective view of a speaker according to a first embodiment of the invention.

FIG. 3 is a plane view of the speaker apparatus according to the first embodiment.

FIG. 4 is a vertical sectional view taken along a line A-A of FIG. 3.

FIG. 5 is a perspective view enlarging a main portion of the speaker apparatus according to the first embodiment.

FIG. 6 is an outline side view showing a state of mounting the speaker apparatus according to the first embodiment to a cabinet.

FIG. 7 is a partial perspective view of a main portion of a speaker apparatus according to a second embodiment of the invention.

FIG. 8 is a partial perspective view of a main portion of a speaker apparatus according to a third embodiment of the invention.

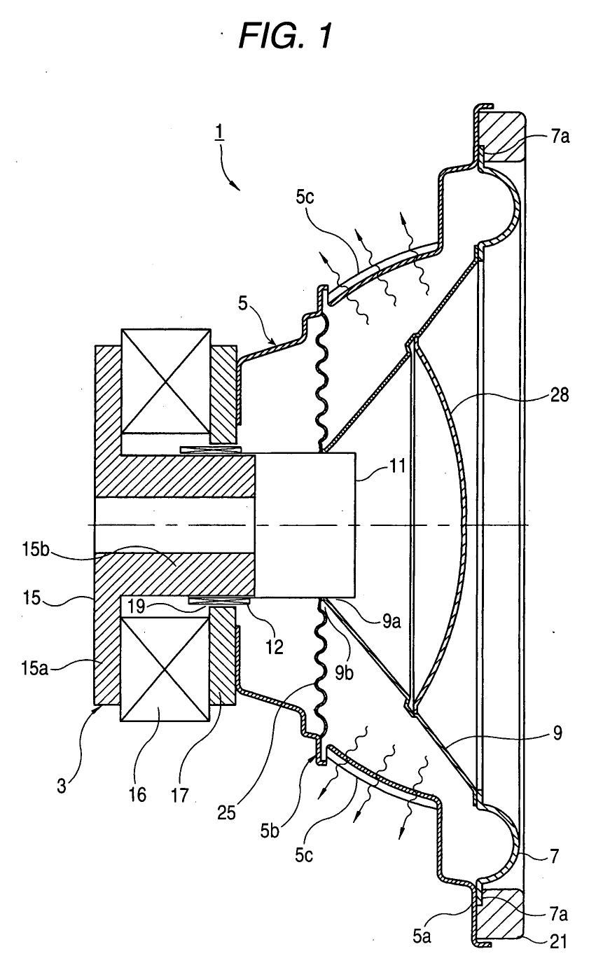

### DESCRIPTION OF THE EMBODIMENTS

According to embodiments of the invention, in the thinned speaker apparatus, the problem that the air flow by the back pressure in driving the vibrating plate is not moved smoothly can be resolved without being accompanied by a reduction in the strength of the speaker frame.

The air flow by the back pressure in driving the vibrating plate can be made to move smoothly and sound quality of the speaker apparatus can be prevented from being deteriorated. Further, by making the air flow move smoothly, heat generated by the magnetic circuit of the speaker apparatus can efficiently be exhausted and therefore, an effect of cooling the magnetic circuit can be promoted.

Embodiments of the present invention will be described hereinbelow by reference to the drawings.

### First Embodiment

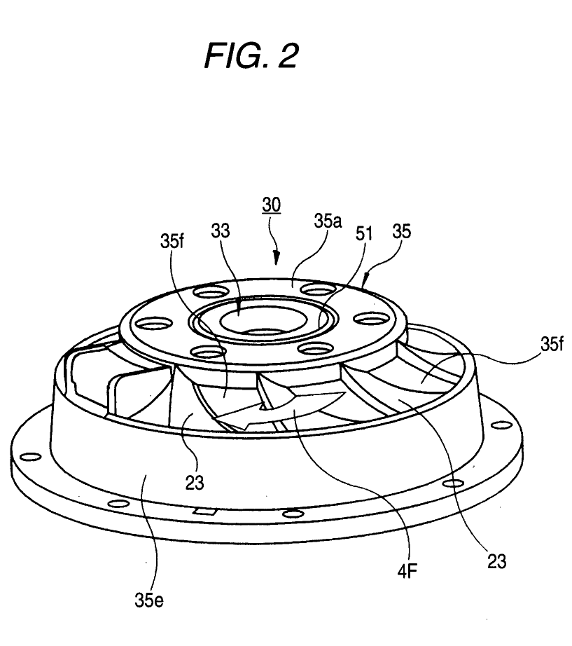

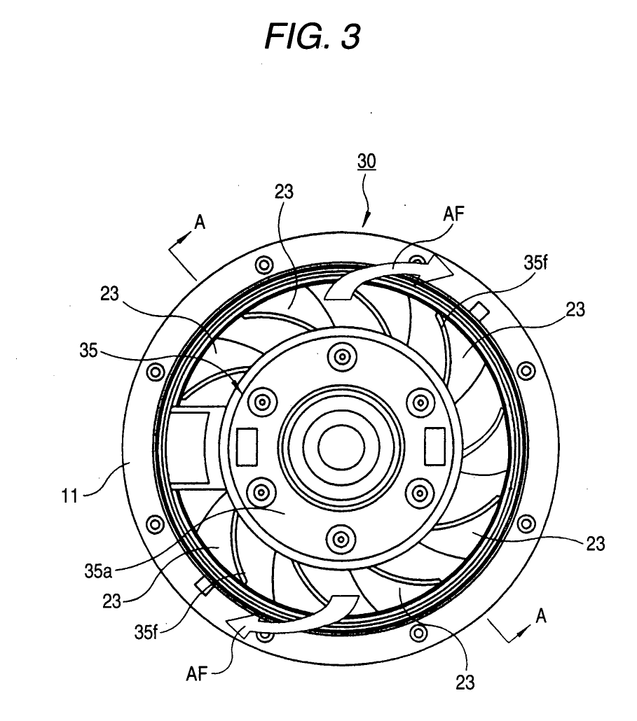

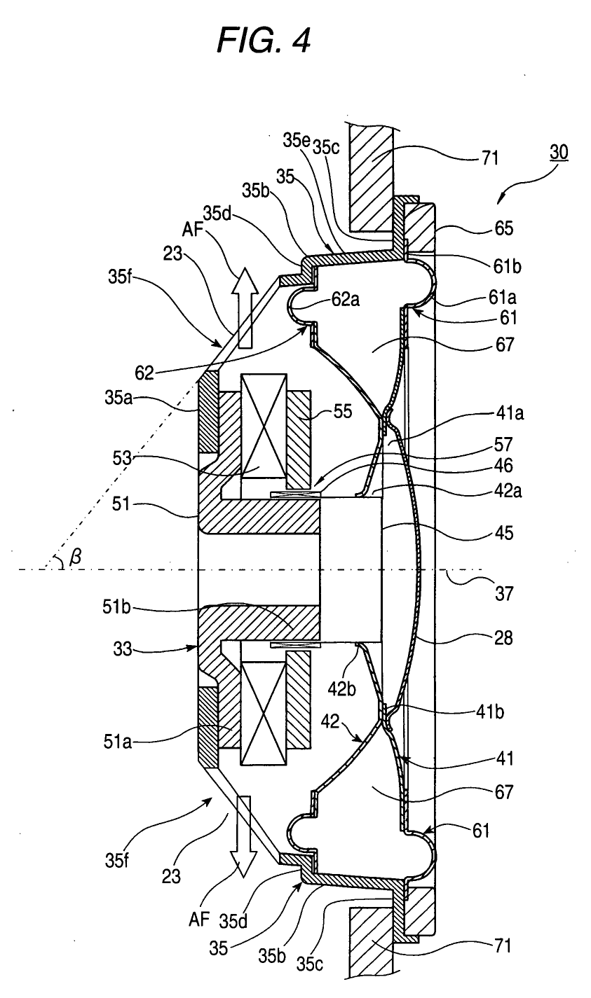

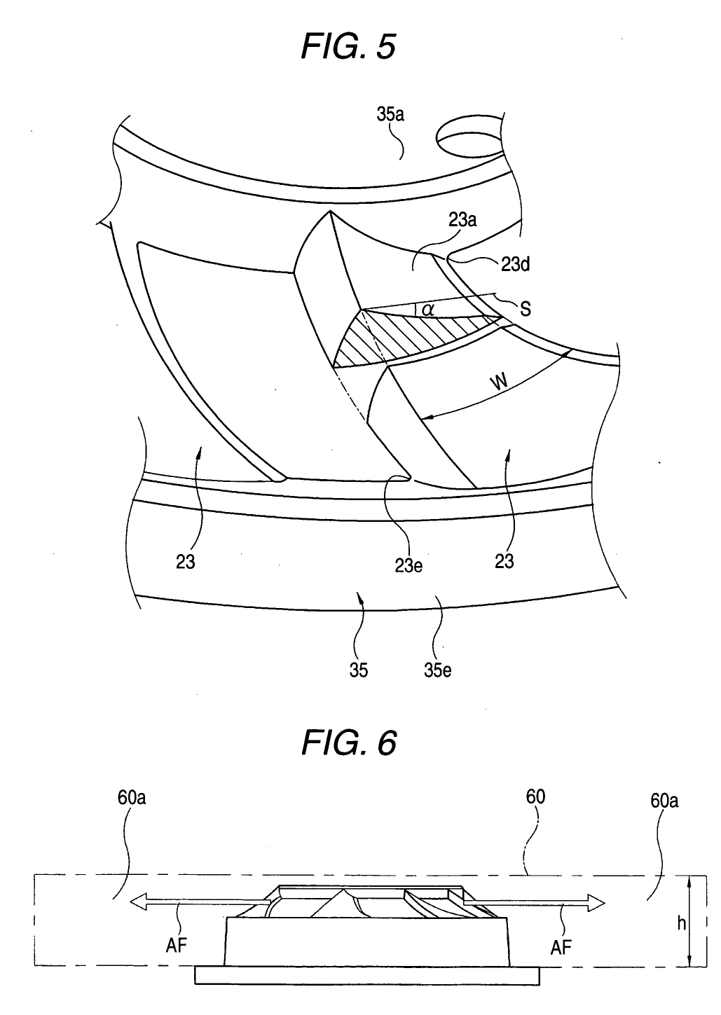

FIG. 2 is a perspective view of a speaker apparatus according to a first embodiment of the invention. FIG. 3 is a plane view of the speaker apparatus according to the first embodiment. FIG. 4 is a vertical sectional view of the speaker apparatus according to the first embodiment. FIG. 5 is a perspective view enlarging a main portion of the speaker apparatus according to the first embodiment. FIG. 6 is an outline side view showing a state of mounting the speaker apparatus according to the first embodiment to a cabinet.

As shown by FIGS. 2, 3 and 4, a speaker apparatus 30 has substantially in a concentric shape centering on a speaker center line 37. The speaker apparatus 30 includes; a magnetic circuit 33; a speaker frame 35 attached with the magnetic circuit 33 at a rear portion thereof; a vibrating plate 41 and a drive member 42 (hereinafter, referred to as drive cone) coaxially arranged in a direction of driving the speaker; and a voice coil 46 wound around a voice coil bobbin 45 in a cylindrical shape.

The magnetic circuit 33 is configured by a yoke 51 having a structure of projecting a center pole 51b in a cylindrical shape at a center of a plate 51a in a shape of a circular plate, a magnet 53 in a ring-like shape fitted to an outer periphery of the center pole 51b, and a top plate 55 in a ring-like shape fitted to a front end side of the center pole 51b to interpose the magnet 53 between the top plate 55 and the plate 51a. A gap between an inner periphery of the top plate 55 and the center pole 51b constitutes a magnetic gap 57 of arranging the voice coil 46.

The speaker frame 35 has a substantially bowl shape and has a shallow bottom. An inner face of a bottom plate portion 35a is pertinently attached with the magnetic circuit 33 in a state of mounting the plate 51a of the yoke 51. The speaker frame 35 is respectively provided with a vibrating plate supporting portion 35c of the vibrating plate 41 and a vibrating plate supporting portion 35d of the drive cone 42 at positions apart from each other along the direction of driving the speaker.

A peripheral wall 35b between the two vibrating plate supporting portions 35c, 35d is configured by a hermetically closed wall in which openings are not provided. On the other hand, the vibrating plate supporting portions 35c, 35d and the bottom plate portion 35a for holding the magnetic circuit 33 are pertinently connected by a connecting portion 23. The connecting portion 23 has a plurality of pieces of openings 35f at pertinent intervals along a circumferential direction of the speaker.

The opening 35f is an opening through which an air flow AF produced by a back pressure of the vibrating plate (an arrow mark indicating the air flow AF in the illustration designates a direction thereof in exhausting) passes and serves as a vent hole for escaping the back pressure. A back face of the vibrating plate supporting portion 35c of the speaker frame 35 serves as a flange face hermetically fixed to a baffle 71 of a speaker cabinet 60.

The vibrating plate 41 and the drive cone 42 are vibrating plates of a cone type, edges 61, 62. The vibrating plate 41 and the drive cone 42 are fixed to the vibrating plate supporting portions 35c, 35d on the speaker frame 35 at outer peripheral portions thereof. The vibrating plate 41 and the drive cone 42 are bonded to be fixed to the voice coil bobbin 45 at inner peripheral portions 41b, 42b.

It may be to use a member of a material having high inner loss for the edges 61, 62 in order to attenuate vibration propagated from cone paper (corresponding to a main body of the vibrating plate). Therefore, the edges 61, 62 may be configured by bonding, for example, members of a material different from that of cone paper (material having inner loss higher than that of cone paper).

According to the vibrating plate 41 arranged on a front face side of the speaker apparatus 30, a diameter of an opening of a center portion thereof is set to be larger than a diameter of an opening of the drive cone 42 arranged on the front face side of the speaker apparatus 30, and the edge 61 is provided with a bulged portion 61a bulged to an outer side of a hermitically closed space 67 between the vibrating plates (front face side of the speaker apparatus).

Further, according to the drive cone 42 arranged at a back portion of the vibrating plate 41, the diameter of the opening of the center portion is set to be substantially equal to an outer diameter of the voice coil bobbin 45, and the edge 62 is provided with a bulged portion 62a bulged to an outer side of the hermetically closed space 67 between the vibrating plates (back face side of the speaker apparatus). Further, directions of recesses and projections of the bulged portion 61a and the bulged portion 62a are not limited to directions as shown by FIG. 4.

The respective edges 61, 62 of the vibrating plate 41 and the drive cone 42 are respectively fixed to the two vibrating plate supporting portions 35c, 35d of the speaker frame 35 mentioned above.

An attaching flange portion 61b continuously provided to an outer peripheral portion of the edge 61 of the vibrating plate 41 is pinched by a gasket 65 and the vibrating plate supporting portion 35c to be fixed to the vibrating plate supporting portion 35c.

The inner peripheral portion 41b of the vibrating plate 41b is bonded to the drive cone 42 in a state of being overlapped on the drive cone 42 disposed on a back side thereof.

A dust cap 28 is pasted to be mounted to a center portion of the vibrating plate 41. The dust cap 28 covers a front side of the voice coil bobbin 45 to prevent dust and dirt or the like from invading the magnetic gap 57.

The inner peripheral portions 41b, 42b of the vibrating plate 41 and the drive cone 42 are to be fixed to the voice coil bobbin 45 by adhering to fix the inner peripheral portion 42b of the drive cone 42 to an outer periphery of the voice coil bobbin 45 by a pertinent adhesive.

The voice coil bobbin 45 in the cylindrical shape is fitted to an outer periphery of the center pole 51b movably in an axial direction and is positioned in a radius direction and in the axial direction by the drive cone 42 bonded to an outer periphery thereof.

The space 67 between the vibrating plates surrounded by the vibrating plate 41 and the drive cone 42 and the speaker frame 35 is hermetically closed.

When the vibrating plate 41 and the drive cone 42 are driven by displacing the voice coil bobbin 45 in the axial direction, as shown by FIG. 4, a gas of air or the like sealed in the hermetically closed space 67 between the vibrating plates is compressed by displacing the vibrating plate 41 and the drive cone 42 and displacing the edges 61a, 62a to achieve spring performance as an air spring, and the voice coil bobbin 45 is controllably supported.

It is not necessary to mount a damper for elastically supporting the voice coil bobbin 45 on the back side of the vibrating plate 41 and the drive cone 42. A speaker apparatus 30 can apply to a vehicle-mounted audio system or the like by shortening a dimension in the axial direction thereof by omitting a damper and a space of installing the damper.

Explaining the above-described connecting portion 23 in details, as shown by FIG. 5, the connecting portion 23 includes an inclined face 23a having an inclination angle α relative to a tangential line direction S of a circumference of the speaker frame 35. The angle of inclination α may be in a range equal to or smaller than 60 degrees. A plurality of the connecting portions 23 has a substantially plate-like shape and directions of inclining the inclined faces 23a are constituted to be substantially the same.

The connecting portion 23 may be with an angle of inclination of 30 degrees through 90 degrees as an angle of inclination β in an axial direction of the speaker relative to the speaker center line 37.

By constituting the connecting portion 23 in this way, the air flow AF coming out from the opening 35f (air flow going to the opening 35f in a direction reverse to the arrow mark of the illustration) is moved along the direction of inclining the inclined face 23a of the connecting portion 23.

Further, by constituting corner portions 23d, 23e of the connecting portion 23 by comparatively large R faces, a strength of the connecting portion 23 can be increased, or a strength of a die can be prevented from being reduced.

The connecting portion 23 is configured by narrowing a width W thereof gradually in a direction of the magnetic circuit 33 and is configured by gradually changing the angle of inclination α in the direction. The configuration of the connecting portion is similar to respective blowing fins of a well-known fan, for example, as shown by FIG. 5, a shape of a cross-sectional face of the connecting portion 23 is configured by substantially a wedge-like shape of thinning a side thereof proximate to the vibrating plate 41. A resistance of air of the connecting portion 23 particularly when air is exhausted to outside of the speaker apparatus is reduced and the air flow AF flows smoothly.

The air flow AF produced by vibrating the vibrating plate 41 and the drive cone 42 constitutes the air flow AF in a direction of a vortex flow centering on the speaker center line 37 along the inclined face 23a of the connecting portion 23. Further, the air flow AF constitutes a flow along a direction (direction of speaker plane) substantially orthogonal to the speaker center line 37.

Since the air flow AF flows to diverge in a direction of the side face of the speaker apparatus 30 in this way, a space on a side of a side face of the speaker apparatus 30 (refer to FIG. 6) can effectively be utilized and the air flow becomes active, and heat generated by the magnetic circuit 33 can effectively be cooled.

Further, different from the case of the damper having the bellows structure in which the deformation is moved between the contiguous bellows (recessed and projected portions) in propagating the vibration, the vibrating plate 41 and the drive cone 42 are not considerably deformed locally, in addition thereto, the back pressure can effectively be released even by the cabinet which is narrow in the direction of the speaker center line 37 and therefore, high quality reproduction of sound without unclear sound can be realized.

According to the first embodiment, as shown by FIG. 6, in a case of being mounted to the thinned cabinet 60, the air flow AF by the back pressure produced by the drive cone 42 flows in the direction substantially orthogonal to the speaker center line 37, such that the air flow AF is diverged in the direction of the side face of the speaker apparatus 30 and therefore, the air flow AF is diverged in a direction of a vortex flow as described above (direction orthogonal to speaker as shown by FIG. 6 when viewed from side face direction).

Therefore, even in the case of the thinned cabinet 60 as shown by FIG. 6, a space 60a in the direction of the side face of the cabinet which is easy to be provided comparatively can effectively be utilized. As a result, according to the speaker apparatus 30, even when the speaker apparatus is applied to the cabinet 60 having the narrow depth dimension on the side of the back face of the speaker, in other words, the thinned cabinet 60, the back pressure can effectively be controlled and reproduced sound quality can be promoted.

Further, also in an operation of cooling the magnetic circuit 33, effective cooling utilizing the shape of the thinned cabinet 60 effectively can be carried out.

### Second Embodiment

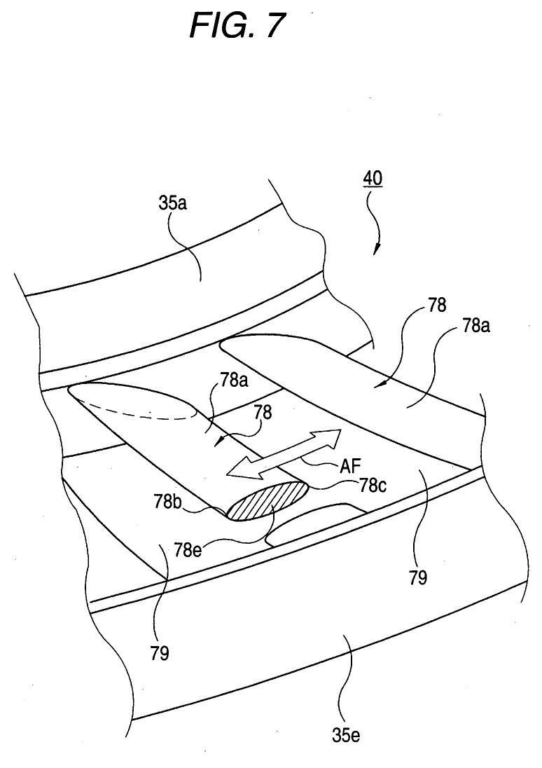

FIG. 7 is a perspective view of a main portion of a speaker apparatus according to a second embodiment of the invention.

According to a speaker apparatus 40 of the second embodiment, as shown by FIG. 7, in a shape of a cross-sectional face of a connecting portion 78, a center portion 78e is configured by a thick wall, both end sides 78b, 78c are configured by a thin-walled streamline shape in the speaker apparatus 30 of the first embodiment shown by FIG. 2 and FIG. 3.

Both front-side and back side faces of the inclined face 78a of the connecting portion 78 are configured by a streamline shape and therefore, a resistance of air of the connecting portion 78 when air is exhausted to outside of the speaker and when air flows thereto can be reduced and the flow of the air flow AF passing an opening 79 can be made to be smoother.

### Third Embodiment

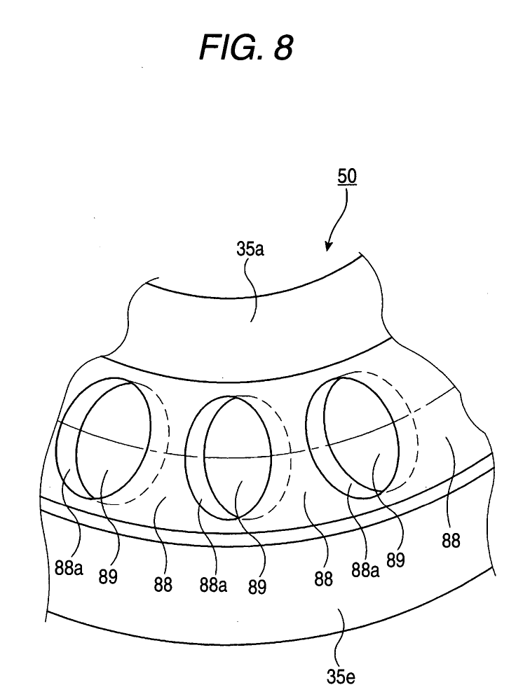

FIG. 8 is a perspective view of a main portion of a speaker apparatus according to a third embodiment.

According to a speaker apparatus 50, as shown by FIG. 8, a shape of an opening 89 formed between connecting portions 88 is configured by an elliptical curved shape having an inclined face 88a in the speaker apparatus 30 of Example 1 shown by FIG. 2 and FIG. 3. Also in the constitution of the connecting portion 88 and the opening 89, not only an effect similar to those of the above-described embodiments is achieved but also, when the opening 89 is configured by the curved shape, there is not an acute angle portion in the connecting portion 88 and therefore, a portion on which an inner stress produced by an external force is concentrated can be avoided and a strength thereof can be increased. Further, the magnet circuit 33 can be held further solidly.

Further, although the elliptical shape is shown as the curved shape of the opening 89, the curved shape is not particularly limited so far as the curved shape is a curved shape which is not provided with an acute angle portion of a circular shape or the like.

Further, the connecting portion and the shape of the opening are not limited by the above-described shapes of the respective embodiments but can pertinently be changed in accordance with the scope of the invention. For example, in the speaker apparatus according to the above-embodiments, the angle of inclination α and the angle of inclination β as well as the size and the shape of the opening or the like of the connecting portion are not limited by a structure formed by a plurality of pieces of same structures but there can also be constructed a constitution in which one speaker apparatus is provided with different connecting portions and openings.

A direction of the air flow can be controlled as desired by the different connecting portions and openings, an optimum structure can be set in consideration of a structure of a cabinet, an environment of arranging a speaker apparatus and the like, and a general purpose speaker apparatus having a wide range of an installing atmosphere can be provided.

As described above in details, the speaker apparatus 30 (40, 50) according to the embodiments is the speaker apparatus 30 (40, 50) including the magnetic circuit 33, the vibrating plate 41 and the drive cone 42 vibrated by the magnetic circuit 33, the speaker frame 35 for holding the magnetic circuit 33 and the vibrating plate, and the connecting portion 23 (78, 88) for connecting the portion of holding the vibrating plate 41 and the drive cone 42 and the portion of holding the magnetic circuit 33, the connecting portion 23 (78, 88) includes the inclined face 23a (78a, 88a) having the angle of inclination relative to the tangential line direction of the circumference of the speaker frame 35 and is constituted such that the air flow by the vibrating plate 41 and the drive cone 42 flows along the inclined face.

Thereby, the movement of the air flow by the back pressure in driving the vibrating plate 41 and the drive cone 42 can be made to be smooth, and a deterioration in sound quality of the speaker apparatus 30 (40, 50) can be prevented. Further, by making the movement of the air flow smooth, heat generated by the magnetic circuit 33 can efficiently be exhausted and therefore, the effect of cooling the magnetic circuit 33 can be promoted.

What is claimed:

1. A speaker apparatus comprising:
a magnetic circuit;
a vibrating plate vibrated by the magnetic circuit;
a speaker frame holding the magnetic circuit and the vibrating plate, and
a connecting portion connecting a portion of holding the vibrating plate and a portion of holding the magnetic circuit, an inclined face of the connecting portion being inclined relative to a direction of tangential line of circumference of the speaker frame, the connecting portion configured to flow air due to a vibration of the vibrating plate along the inclined face thereof.

2. The speaker apparatus according to claim 1, wherein the connecting portion consists of a plurality of the connecting portions which have a substantially plate-like shape, and
wherein inclination of inclined faces of the plurality of the connecting portions are substantially the same.

3. The speaker apparatus according to claim 1, wherein a width of the connecting portion is gradually narrowed, and
wherein an inclination angle of the inclined face of the connecting portion is gradually changed toward a direction of the magnetic circuit.

4. The speaker apparatus according to claim 1, wherein, in a cross sectional face of the connecting portion, the connecting portion has such a substantially wedge-like shape that the connecting portion is thin-walled at a side proximate to the vibrating plate.

5. The speaker apparatus according to claim 1, wherein in a cross sectional face of the connecting portion, the connecting portion has such a substantially stream shape that a center portion of the connecting portion is thick-walled and both end sides of the connecting portion are thin-walled.

6. The speaker apparatus according to claim 1, wherein an opening formed by the connecting portion has a substantially curved shape.

7. The speaker apparatus according to claim 1, wherein a driving member and the vibrating plate are coaxially disposed along a direction of driving the magnetic circuit,
wherein the vibrating plate and the driving member are fixed to a vibrating plate supporting portion at outer peripheral portion thereof,
wherein the vibrating plate and the driving member are bonded to be fixed to a voice coil bobbin at inner peripheral portion thereof,
wherein a space surrounded by the vibrating plate and the drive member and the speaker frame is hermetically closed, and
wherein a vibrating system is supported through the voice coil bobbin by a spring performance of a gas at inside of the space.
